(19) United States
(12) Patent Application Publication
(10) Pub. No.: US 2020/0063472 A1
(43) Pub. Date: Feb. 27, 2020

(54) GUARD FOR A LATCH TO PREVENT OPENING

(71) Applicant: SAM CASTERNOVIA, WARREN, NJ (US)

(72) Inventor: SAM CASTERNOVIA, WARREN, NJ (US)

(21) Appl. No.: 16/106,143

(22) Filed: Aug. 21, 2018

(51) Int. Cl. E05C 17/16; E05B 15/12; E05C 19/18

(52) U.S. Cl. CPC E05C 17/166; E05C 19/184; E05B 17/2023

(57) ABSTRACT

A door latch locking guard 30 is provided for maintaining a door in a locked position. A door latch 10 has an existing stationary latch arm 12 and the door jam has an existing swinging arm 14 for engaging the latch arm 12 to lock the door. The present invention provides a protective locking guard 30 having a notch 38 formed therein for placing over the stationary latch arm 12, and the protective locking guard 30 also has a plate 32 for moving the existing swinging arm 14 over the plate 32. A locking clasp 40 is provided for inserting through an opening 36 in plate 32 in order to prevent the door latch 12 from being opened from the opposite side of the door.

### FIELD OF THE INVENTION

This invention relates to a locking guard that is placed on an existing stationary door latch arm 12 to prevent the door latch from being opened by a person on the other side of the door.

### BACKGROUND OF THE INVENTION

Door latches are typically used to lock a door, and also allows the door to be partially opened without opening the latch. The typical latch includes a fixed latch arm 12 mounted on the door, and a swinging arm 14 which is mounted next to the door and is moved to engage the latch arm 12 to lock the door.

The problem with such door latches is that they are not secure, since devices have been developed that can be slid through the door crack to unlock the latch from outside the door.

The present invention has been developed to solve this problem, by preventing someone outside the door from inserting a device to open the door latch.

### DESCRIPTION OF THE PRIOR ART

There are a number of prior art patents that provide improved door latches, but they have not solved the problem.

U.S. Pat. No. 7,905,525 shows a U-shaped latch cover. U.S. Pat. No. 4,062,578 shows an enlarged ball 23 to prevent the latch from being completely opened. U.S. Published Patent Application No. 2015/0097381 discloses a ball locking member 37 for a door latch. U.S. Pat. No. 4,229,030 discloses a safety door fastening device to retain and limit the angle of openings.

U.S. Patent Application Publication No. 2005/0052035 to Chikara Yamashita discloses a door security latch in which the range of motion of a secured door is variable depending on the degree to which the latch is engaged. Like most prior art latches, Yamashita discloses an arm with a substantially spherical member is mounted to the inside surface of a door such that the arm extends beyond the free edge of the door. A pivotable first yoke mounted to the door frame engages the arm and substantially spherical member such that as the arm travels along the first yoke, the substantially spherical member constrains the arm within the first yoke, limiting the doors swing to the length of the first yoke. A second yoke is also provided which engages the substantially spherical member more closely, limiting the swing of the door to a fraction of an inch. However, the '035 patent application to Yamashita does not disclose a locking pin for inserting through an opening in a locking guard and a plate for passing through the swinging arm.

Thus, the prior art patents do not disclose the present invention.

### Objects of the Invention

It is an object of the present invention to provide a locking guard which is placed over a door latch to make it secure, so that the door latch cannot be unlatched from outside the door.

It is another object of the present invention to provide a locking guard having a notch which is placed over the door latch to make it secure, so that the door latch cannot be unlatched from outside the door.

It is another object of the present invention to provide a locking guard having a plate for passing through the swinging arm, wherein the plate receives a locking clasp 40 to prevent the door latch from being opened from the other side of the door.

Another object of the present invention is to provide a locking guard which is inexpensive and easy to install, and easy to remove from the door latch.

Another object of the present invention is to provide a locking guard that allows the existing door lock to open partially as designed to view outside the door and still be secure.

### SUMMARY OF THE INVENTION

A door latch locking guard 30 is provided for maintaining a door in a locked position. A door latch 10 has an existing stationary latch arm 12 and the door jamb has an existing swinging arm 14 for engaging the latch arm 12 to lock the door. The present invention provides a protective locking guard 30 having a notch 38 formed therein for placing over the stationary latch arm 12, and the protective locking guard 30 also has a plate 32 for moving the existing swinging arm 14 over the plate 32. A locking clasp 40 is provided for inserting through an opening 36 in plate 32 in order to prevent the door latch 12 from being opened from the opposite side of the door.

### BRIEF DESCRIPTION OF THE DRAWINGS

FIG. 1 shows a typical door latch and swinging arm without the locking guard of the present invention installed on the door latch;

FIG. 2 shows the locking guard 30, including the plate 32 and notch 38;

FIG. 3 shows the locking guard 30 in a partially unlocked position;

FIG. 4 shows the locking guard 30 in a fully locked position; and

FIG. 5 shows the locking guard 30 in a fully locked position with the locking clasp 40 inserted through the plate 36.

### DETAILED DESCRIPTION OF THE FIRST EMBODIMENT

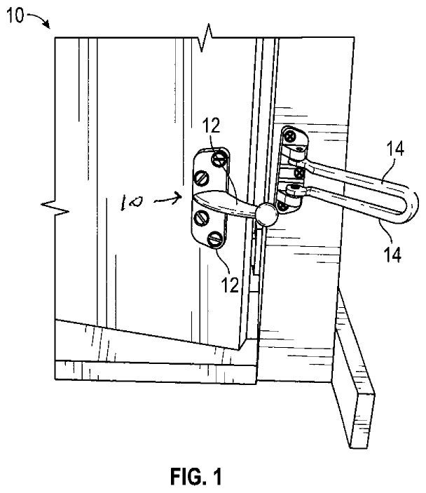

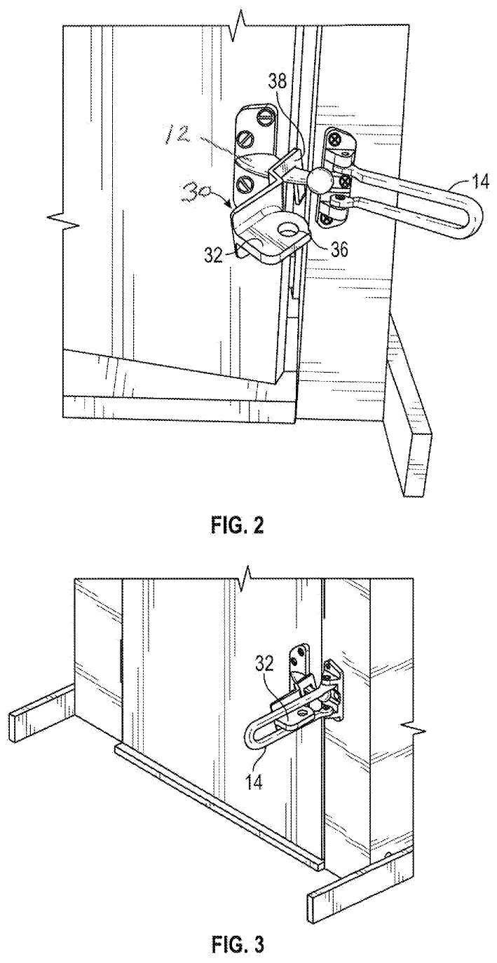

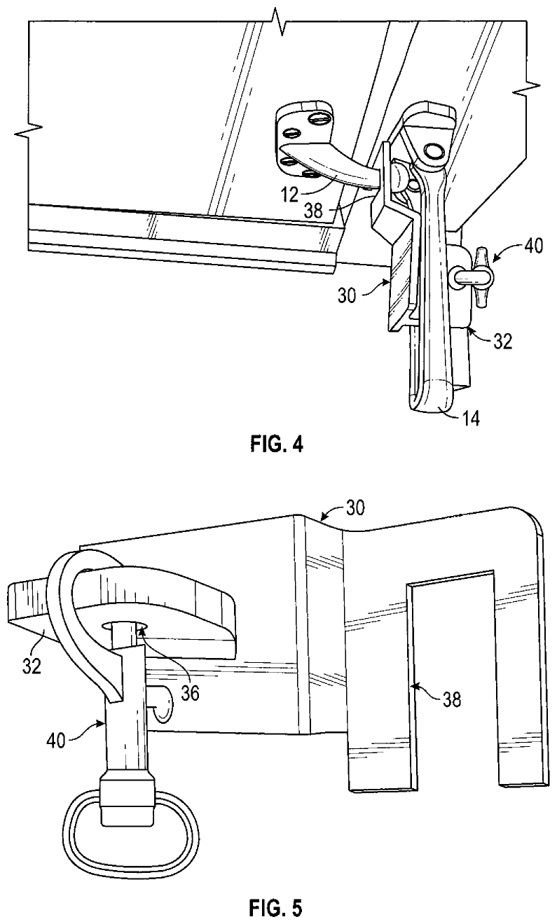

FIGS. 1 to 5 show a typical door latch security device 10, which includes a fixed latch arm 12 on a door and a swinging arm 14 on the door jam.

The present invention provides a protective locking guard 30, which includes a flat horizontal plate 32 and also includes a notch 38 for placing over and engaging the latch arm 12. The horizontal plate 32 passes through the spaced apart horizontal bars of the swinging arm 14 to lock the latch in place. Flat plate 32 includes a hole 36 for receiving therethrough a locking clasp 40 to hold the locking guard 30 in place.

As a result, the locking guard 30 prevents the door latch 10 from being opened from the other side of the door, while still allowing the latch arm 12 to travel along the swinging arm 14 for partial opening of the door while securing it from opening.

### OPERATION OF THE INVENTION

In operation, the door is latched with latch arm 12 and swinging arm 14. To install protective locking guard 30, the door is unlatched and the door is moved to the closed position. Then, the notch 38 is placed over the latch arm 12. Next, the horizontal plate 32 is moved between the horizontal bars of swinging arm 14 to lock the latch arm 12 in place. Next, the locking clasp 40 is inserted through hole 36 to hold the locking guard 30 in place.

To release the locking guard 30 of the present invention, the locking clasp 40 is removed from opening 36. Then the horizontal plate 32 is removed from between the horizontal bars of swinging arm 14. Then, notch 38 is removed from latch arm 12, and the door is unlocked and opens.

As a result, the locking guard 30 prevents the door latch from being opened from the other side of the door. However, when engaged, it still allows the latch arm 12 to travel along the swing arm 14 for partial opening of the door while securing it from opening.

### Advantages of the Present Invention

It is an advantage of the present invention is to provide a locking guard having a notch which is placed over the door latch to make it secure, so that the door latch cannot be unlatched from outside the door.

Another advantage of the present invention is to provide a locking guard having a plate for passing through the swinging arm, wherein the plate receives a locking clasp to prevent the door latch from being opened from the other side of the door.

Another advantage of the present invention is to provide a locking guard which is inexpensive and easy to install, and easy to remove from the door latch.

Another advantage of the present invention is to provide a locking guard that allows the existing door lock to open partially as designed to view outside the door and still be secure.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A door latch locking guard 30 for maintaining a door in a locked position, the door having a door latch 10 having an existing stationary latch arm 12 and a door jamb having an existing swinging arm 14 for engaging the latch arm 12 to lock the door, while still allowing the latch arm 12 to travel along the swinging arm 14 for partial opening of the door while securing the door from being moved to a fully open position, comprising:
a) a protective locking guard 30 having a notch 38 formed therein for placing over the stationary latch arm 12;
b) said protective locking guard 30 having a plate 32 for moving said existing swinging arm 14 over said plate 32; and
c) a locking clasp 40 for inserting through an opening 36 in plate 32 in order to prevent said door latch 12 from being opened from an opposite side of the door.

2) A door latch locking guard 30 for maintaining a door locked, having a door latch 10 having an existing stationary latch arm 12 and a door jam having an existing swinging arm 14 for engaging the latch arm 12 to lock the door, said swinging arm 14 having spaced apart horizontal arms for allowing partial opening of the door while securing the door from being moved to a fully open position, comprising:
a) a protective locking guard 30, having a horizontal plate 32 and a vertical notch 38 for placing over and engaging the existing latch arm 12;
b) said horizontal plate 32 having an opening 36, said horizontal plate for passing through said spaced apart horizontal arms of said swinging arm 14; and
c) a locking clasp 40 for inserting through said opening 36 in said locking guard 30, in order to prevent said door latch from being opened from an opposite side of the door.
